(19) United States
(12) Patent Application Publication
(10) Pub. No.: US 2023/0214217 A1
(43) Pub. Date: Jul. 6, 2023

(54) METHOD AND DEVICE FOR PROVIDING A VECTOR STREAM INSTRUCTION SET ARCHITECTURE EXTENSION FOR A CPU

(71) Applicants: Maziar GOUDARZI, Toronto (CA); Reza AZIMI, Aurora (CA); Man Pok HO, Markham (CA); Zhizhao QIAN, Markham (CA)

(72) Inventors: Maziar GOUDARZI, Toronto (CA); Reza AZIMI, Aurora (CA); Man Pok HO, Markham (CA); Zhizhao QIAN, Markham (CA)

(21) Appl. No.: 17/570,349

(22) Filed: Jan. 6, 2022

(51) Int. Cl. G06F 9/30; G06F 9/38

(52) U.S. Cl. CPC G06F 9/30036; G06F 9/3802; G06F 9/30181

(57) ABSTRACT

A method and device for providing a vector stream instruction set architecture extension for a CPU. In one aspect, there is provided a vector stream engine unit comprising: a first fast memory storage for temporarily storing data of vector data streams from a memory for loading into a vector register file; a second fast memory storage for temporarily storing data of the vector data streams from the vector register file for loading into the memory; a prefetcher configured to prefetch data of the vector data streams from the memory into the first fast storage memory, and prefetch data of the vector data streams from the vector register file into the second fast storage memory; and a stream configuration table (SCT) storing stream information for prefetching data from the vector data streams.

### TECHNICAL FIELD

The present disclosure relates to processing units and computer architecture, and in particular to a method and device for providing a vector stream instruction set architecture extension for a central processing unit (CPU).

### BACKGROUND

Generally, memory access latency in computing is high and is often the system performance bottleneck. In fields such as high performance computing (HPC), digital signal processing (DSP), artificial intelligence (AI)/machine learning (ML) and computer vision (CV) similar computation operations are repeatedly performed on data stored in memory, often in the form of streams. In the case of loops or nested loops within an application, similar operations are repeatedly performed on data, which presents a considerable obstacle to performance given the limitations of memory access. To improve efficiency of the memory accesses, instructions and/or data that are likely to be accessed by CPUs are copied over from memory locations wherein the data is stored to faster local memory, such as local cache memory, through an operation known as prefetching.

Array-based memory accesses can be categorized into two types based on the index value type, direct memory access for index values based on an induction variable and indirect memory access for index values based on another array access. The effectiveness of prefetching operation is greatly diminished using existing solutions in the case of indirect array-based memory access, wherein the access is defined in an array structure wherein the array index is defined by another array access.

### SUMMARY

The present disclosure provides a method and device for providing a vector stream instruction set architecture extension for a CPU and for processing vector data streams. Both general-purpose CPUs and domain-specific CPUs can be designed into broadly defined architecture types with an instruction set architecture (ISA) for each processor. The vectorized stream instruction set of the present disclosure may be used with general-purpose and domain-specific CPUs. In various examples described herein, there is provided a vector ISA extension that operates on multiple data streams configured in vector format in parallel (i.e., concurrently). An ISA represents an abstract model of a computer. An ISA can be implemented, or realized, in the form of a physical CPU. The vector ISA extension of the present disclosure extends an ISA so that it can process vector data streams. The vector ISA extension maintains dependency relationships between arrays of the vector data streams. The vector data streams may be processed vectorially wherein array index calculation in batches is enabled by determining array indices from registers based on the dependency relationship. An explicit instruction to retrieve memory for a higher-level dependency stream causes implicit instructions to be performed from one or more of the vector data streams from which the higher-level dependency stream depends. The vector ISA extension of the present disclosure enables the processing unit(s) of a host computing device to issue vector instructions in addition to scalar instructions. The present disclosure also provides a Vector Stream Engine Unit (V-SEU). The V-SEU is a hardware processing unit which is configured to execute vector streams output from the vector processing ISA extensions.

In accordance with a first aspect of the present disclosure, there is provided a method of processing vector data streams by a processing unit, the method comprising: initiating a first vector data stream for a first set of array-based memory accesses, wherein the first vector data stream is associated with a first array index for advancing the first set of array-based memory accesses, wherein the first array index is an induction variable; initiating a second vector data stream for a second set of array-based memory accesses, wherein the second vector data stream is associated with a second array index for advancing the second set of array-based memory accesses, wherein the second array index is dependent on array values of the first set of array-based memory accesses; prefetching a first plurality of data elements requested by the first set of array-based memory accesses from a memory into a first fast memory storage by advancing the first array index by a plurality of increments; prefetching a second plurality of data elements requested by the second set of array-based memory accesses from a vector register file into a second fast memory storage, wherein the second array index is advanced as the first plurality of data is used as array values; and processing a plurality of the prefetched second plurality of data elements through an explicit instruction for the second vector data stream, wherein the execution of the explicit instruction causes the processing unit to translate the explicit instruction to an implicit instruction to execute a plurality of the prefetched first plurality of data elements.

In some or all examples of the first aspect, the first plurality of data elements and the second plurality of data elements are prefetched based on stream information stored in a stream configuration table (SCT).

In some or all examples of the first aspect, an initial value and end value of the induction variable and the base address of the first set of array-based memory accesses are stored in the SCT for the first vector data stream.

In some or all examples of the first aspect, the stream information of the SCT includes stream dependency relationship information.

In some or all examples of the first aspect, the method further comprising: determining conflicts in the second plurality of data elements prior to prefetching the second plurality of data elements; and serializing at least the conflicting data elements of the second plurality of data elements in response to detection of a conflict during the prefetching of the second plurality of data elements.

In some or all examples of the first aspect, only the conflicting data elements are serialized during the prefetching of the second plurality of data elements.

In some or all examples of the first aspect, the method further comprises: generating a conflict mask in response to detection of a conflict; wherein the conflicting data elements are serialized using the conflict mask

In some or all examples of the first aspect, the vector data streams are processed vectorially while maintaining dependency relationships between arrays of the vector data streams, wherein array-index calculation is performed in batches by determining array-index values from registers of the vector register file based on the dependency relationships.

In some or all examples of the first aspect, the method further comprises: converting scalar instructions to vector instructions comprising the first vector data stream and second vector data stream.

In accordance with a second aspect of the present disclosure, there is provided a system, exemplarily, which may be a vector stream engine unit, comprising: a first fast memory storage for temporarily storing data of vector data streams from a memory for loading into a vector register file; a second fast memory storage for temporarily storing data of the vector data streams from the vector register file for loading into the memory; a prefetcher configured to prefetch data of the vector data streams from the memory into the first fast storage memory, and prefetch data of the vector data streams from the vector register file into the second fast storage memory; and a stream configuration table (SCT) storing stream information for prefetching data from the vector data streams.

In some or all examples of the second aspect, an initial value and end value of the induction variable and the base address of the first set of array-based memory accesses are stored in the SCT for the first vector data stream.

In some or all examples of the second aspect, the stream information of the SCT includes stream dependency relationship information.

In some or all examples of the second aspect, the first fast memory storage and second fast memory storage are First-In-First-Out (FIFO) buffers.

In some or all examples of the second aspect, the FIFOs have a size based on a prefetching depth.

In some or all examples of the second aspect, the data in each vectorized data stream is accessed in vector batches of a fixed size and the FIFO size is a multiple of a size of the vector batches of the vector data streams.

In some or all examples of the second aspect, multiplexers select signals of the vector stream engine unit and pass the selected signal to the memory or vector register file in accordance with a respective signal type.

In some or all examples of the second aspect, the vector data streams are comprised of a sequence of memory accesses having repeated patterns that are the result of loops and nested loops.

In some or all examples of the second aspect, the vector data streams are classified into two groups consisting of memory streams that define a memory access pattern and induction streams that define a repeating pattern of values.

In some or all examples of the second aspect, the memory streams are dependent on either an induction stream for direct memory access or another memory stream for indirect memory access.

In some or all examples of the second aspect, the vector stream engine unit further comprises a compiler for compiling source code and porting the compiled code to at least one processing unit of a host computing device for execution.

In some or all examples of the second aspect, the vector stream engine unit is configured to perform the methods described above in the first aspect and herein.

In accordance with a further aspect of the present disclosure, there is provided a computing device comprising a processor, a memory and a communication subsystem. The memory having tangibly stored thereon executable instructions for execution by the processor. The executable instructions, in response to execution by the processor, cause the computing device to perform the methods described above and herein.

In accordance with a further aspect of the present disclosure, there is provided a non-transitory machine-readable medium having tangibly stored thereon executable instructions for execution by a processor of a computing device. The executable instructions, in response to execution by the processor, cause the computing device to perform the methods described above and herein.

Other aspects and features of the present disclosure will become apparent to those of ordinary skill in the art upon review of the following description of specific implementations of the application in conjunction with the accompanying figures.

### BRIEF DESCRIPTION OF THE DRAWINGS

FIG. 1 is a simplified block diagram of a computing device which may be used to implement exemplary embodiments of the present disclosure.

FIG. 2 is a block diagram of select components of a Vector Stream Engine Unit (V-SEU) in accordance with an example embodiment of the present disclosure.

FIG. 3 illustrates a flowchart of a method for executing vector instructions by a processing unit to process a stream of array-based memory accesses.

FIG. 4 illustrates an example of simplified index streams in which duplicate entries in one stream causes conflicts in another stream.

FIG. 5 is a block diagram of a vector instruction processing pipeline in accordance with an example embodiment of the present disclosure.

FIG. 6A shows sample code of a loop generating array-based memory access instruction.

FIG. 6B shows sample code corresponding to the sample code of FIG. 6A expressed in vectorized stream instructions in accordance with exemplary embodiments of the present disclosure.

### DETAILED DESCRIPTION OF EXAMPLE EMBODIMENTS

The present disclosure is made with reference to the accompanying drawings, in which embodiments are shown. However, many different embodiments may be used, and thus the description should not be construed as limited to the embodiments set forth herein. Rather, these embodiments are provided so that this application will be thorough and complete. Wherever possible, the same reference numbers are used in the drawings and the following description to refer to the same elements, and prime notation is used to indicate similar elements, operations or steps in alternative embodiments. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although they are illustrated separately for ease of explanation herein. Different devices may have different designs, such that although some devices implement some functions in fixed function hardware, other devices may implement such functions in a programmable processor with code obtained from a machine-readable medium. Lastly, elements referred to in the singular may be plural and vice versa, except wherein indicated otherwise either explicitly or inherently by context.

Indirect memory access can be difficult for a prefetcher to process because the actual data element being accessed depends on the values of other arrays. Hence, each memory access may be random in practice, thereby causing substantial misses in the cache hierarchy resulting in poor prefetching accuracy. Further, when array accesses are converted to an assembly language, a number of assembly instructions are required to calculate the memory address to load the instructions from. In the case of indirect memory accesses, additional instructions for address calculation are required for each additional level of indirection before the correct data can be accessed and loaded from memory. The overhead in address calculation further exacerbates the performance degradation.

There are two major drawbacks associated with the approaches of the prior art. Firstly, only scalar operations are supported by the proposed stream instruction set architecture (ISAs). Specifically, the existing proposals for a streaming ISA, or similar ideas, do not go beyond scalar data elements. At each access point, the software is loading/storing a single data element of the stream, and correspondingly, the stream is also advanced by a single element at each loop iteration. Thus, the data consumption rate, and thereby the result generation rate, per stream is limited to one element per loop iteration. This significantly limits the gain potentially attainable by the streams prefetched by the hardware.

Secondly, the streams are often consumed by vector instructions, which necessitates additional preparations, precautions, or support. Streams usually occur in hot loops of the application programs and thus they inherently contain repetitive operations on a multitude of data elements in arrays. Consequently, the streams lend themselves well to vector operations, and indeed current compilers vectorize many such loops. However, when vectorized, even if only one of the vector operands is not available due to a cache miss, the entire vector instruction must wait, thereby resulting in additional stall cycles.

The embodiments of the present disclosure provide methods and systems for a vector stream instruction processing by a computing device. With the implementation of embodiments and examples described below in the present disclose, above drawbacks could be overcome accordingly.

Within the present disclosure, the following sets of terms are used interchangeably: arrays and streams.

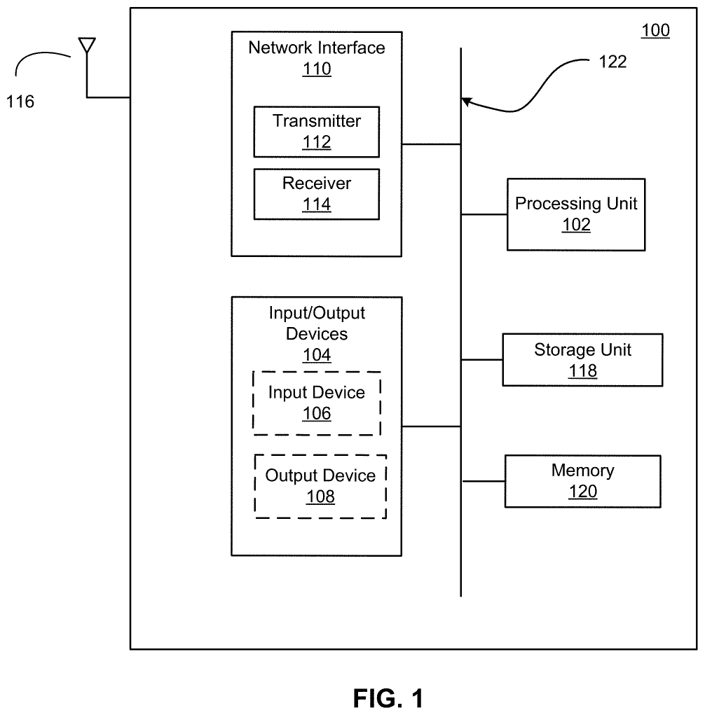

FIG. 1 is a simplified block diagram of a computing device 100 which may be used to implement methods and systems described herein. Other computing devices suitable for implementing the present invention may be used, which may include components different from those discussed below. In some example embodiments, the computing device 100 may be implemented across more than one physical hardware unit, such as in a parallel computing, distributed computing, virtual server, or cloud computing configuration. Although FIG. 1 shows a single instance of each component, there may be multiple instances of each component in the computing device 100.

The computing device 100 includes at least one processing unit (also known as a processor) 102 such as a central processing unit (CPU) with an optional hardware accelerator, a vector processing unit (also known as an array processing unit), a graphics processing unit (GPU), a tensor processing unit (TPU), a neural processing unit (NPU), a microprocessor, an application-specific integrated circuit (ASIC), a field-programmable gate array (FPGA), a dedicated logic circuitry, a dedicated artificial intelligence processor unit, or combinations thereof.

The computing device 100 may also include one or more input/output (I/O) interfaces 104, which may enable interfacing with one or more appropriate input devices 106 and/or output devices 108. In the example shown, the input device(s) 106 (e.g., a keyboard, a mouse, a microphone, a touchscreen, and/or a keypad) and output device(s) 108 (e.g., a display, a speaker and/or a printer) are shown as optional and external to the computing device 100. In other examples, one or more of the input device(s) 106 and/or the output device(s) 108 may be included as a component of the computing device 100. In other examples, there may not be any input device(s) 106 and output device(s) 108, in which case the I/O interface(s) 104 may not be needed.

The computing device 100 may include one or more network interfaces 110 for wired or wireless communication with a network. In example embodiments, network interfaces 110 include one or more wireless interfaces such as transmitters 112 that enable communications in a network. The network interface(s) 110 may include interfaces for wired links (e.g., Ethernet cable) and/or wireless links (e.g., one or more radio frequency links) for intra-network and/or inter-network communications. The network interface(s) 110 may provide wireless communication via one or more transmitters 112 or transmitting antennas, one or more receivers 114 or receiving antennas, and various signal processing hardware and software. In this regard, some network interface(s) 110 may include respective computing systems that are similar to computing device 100. In this example, a single antenna 116 is shown, which may serve as both transmitting and receiving antenna. However, in other examples there may be separate antennas for transmitting and receiving.

The computing device 100 may also include one or more storage units 118, which may include a non-transitory machine-readable medium (or device) such as a solid-state drive, a hard disk drive, a magnetic disk drive and/or an optical disk drive. The computing device 100 includes memory 120, which may include a volatile or non-volatile memory, such as flash memory, random access memory (RAM), and/or a read-only memory (ROM). The storage units 118 and/or memory 120 may store instructions for execution by the processing units(s) 102 to carry out the methods of the present disclosure as well as other instructions, such as for implementing an operating system or other applications/functions.

The storage devices (e.g., storage units 118 and/or non-transitory memory(ies) 120) may store software source code of the vector ISA extension for a general-purpose processor architecture or domain-specific processor architecture. The memory 120 may also include a Load-Store Queue and L1 Data cache wherein data elements are read from for loading stream operations or written to for storing stream operations.

In some examples, one or more data sets and/or module(s) may be provided by an external memory (e.g., an external drive in wired or wireless communication with the computing device 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

The computing device 100 may also include a bus 122 providing communication among components of the computing device 100, including the processing units(s) 102, I/O interface(s) 104, network interface(s) 110, storage unit(s) 118, memory(ies) 120. The bus 122 may be any suitable bus architecture including, for example, a memory bus, a peripheral bus or a video bus.

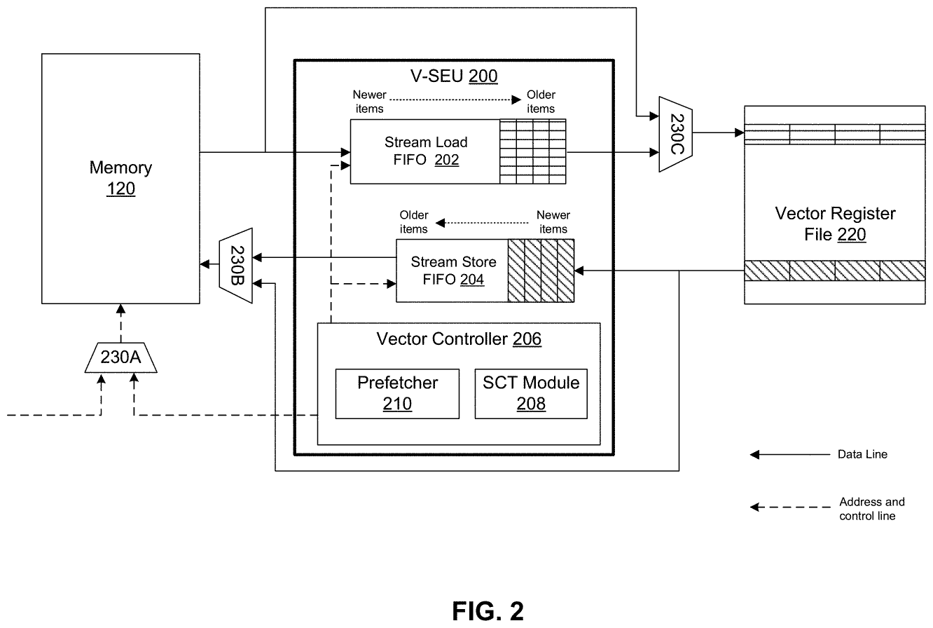

FIG. 2 is a block diagram of a Vector Stream Engine Unit (V-SEU) 200 in accordance with an example embodiment of the present disclosure. In the illustrated embodiment, the V-SEU 200 includes stream load FIFO 202, stream store FIFO 204, and a vector controller 206. The V-SEU 200 is a special-purpose processing unit supporting the processing unit(s) 102 of the computing device 100, which may be a general-purpose CPU or a domain-specific CPU. The V-SEU 200 serves as a FIFO addition to the memory 120. The V-SEU 200 is coupled to the memory 120 and a vector register file 220 of the computing device 100 as shown. In the illustrated embodiment, data lines (or paths) are shown in solid lines whereas and address and control lines (or paths are shown in dashed lines. Multiplexers (MUXs) 230A, 230B, and 230C are used to select an appropriate signal that is passed to the memory 120 or vector register file 220 based on the signal type. The V-SEU 200 may also comprise a V-SEU compiler (not shown) in some embodiments. The V-SEU complier is a software layer that compiles source code for the vector ISA extension and ports the compiled code to processing unit(s) 102 for execution. The compiler generates a V-SEU binary executable generated by compiling the source code that is compatible with the vector ISA extension used by the processing unit(s) 102. The vector ISA extension may be used to generate the vector instructions from scalar instructions and vice versa. Methods of converting between scalar and vector instructions are known in the art and are outside of the scope of the present disclosure.

The vector register file 220 comprises a plurality of vector registers. Each vector register includes a plurality of elements. The vector register file 220 is configured to perform a method including receiving a read command at a read port of the vector register file 220. The read command specifies a vector register address. The vector register address is decoded by an address decoder to determine a selected vector register of the vector register file 220. An element address is determined for one of the plurality of elements associated with the selected vector register based on a read element counter of the selected vector register. A data element in a memory array of the selected vector register is selected as read data based on the element address. The read data is output from the selected vector register based on the decoding of the vector register address by the address decoder.

The stream load FIFO 202 and the stream store FIFO 204, collectively referred to as stream FIFOs, are configured to temporarily hold data fetched from memory 120 or from the vector register file 220 in vector format when reading from, or writing to, registers of the vector register file 220. Streams are comprised of a sequence of memory accesses having repeated patterns that are the result of loops and nested loops. Each memory access of a stream may be identified through a register of the vector register file 220, which is a special-purpose register identifier that may be used to refer to data within a particular stream. Each register of the vector register file 220 may be defined with a register width that in turn determines the amount of data that may be loaded or stored by each instruction. In instances wherein the entirety of the register data is not used, a mask may be used to define the useful portion of register data as described in more detail below. In vector instructions in accordance with the present disclosure, instruction operands may be delivered from the vector register file 220.

In some embodiments, the streams may be classified into two groups: memory streams that describe a memory access pattern; and induction streams that define a repeating pattern of values. Memory streams may be dependent on either an induction stream (direct memory access) or another memory stream (indirect memory access).

The stream FIFOs 202, 204 are configured to hold data to be consumed, or generated, by vector instructions issued from the processing unit(s) 102 of the computing device 100. It is understood that despite only two FIFOs being shown in FIG. 2, the actual number of FIFOs may vary depending on the number of simultaneous streams that could be supported by specific implementations of the present disclosure. The number of FIFOs is limited by the number of bits allocated to identifying the stream of interest as well as by the amount of allocated hardware resources to accommodate those FIFO data storage and associated logic circuits. The size (or depth) of the FIFOs may be selected based on a prefetching depth. In some embodiments, the data elements in each stream are accessed in vector batches of a fixed size and the FIFO size is a multiple of a size of the vector batches of the stream. The nature of the FIFO storage means that the temporal order in which data elements are loaded into the FIFO is also the temporal order in which they are extracted from the FIFO.

The vector controller 206 includes a Stream Configuration Table (SCT) module 208, a prefetcher 210, and any additional control logic based on the application. The SCT module 208 is a memory or cache that maintains a stream configuration table. The SCT module 208 and prefetcher 210 may be implemented in firmware. On the memory interface side, appropriate logic, for memory-address generation and tracking, should be added to do the prefetch by contacting appropriate components of the processing unit(s) 102. This is implementation dependent, based on amount of parallel address-calculation circuitry the implementer wishes to dedicate, and should be designed accordingly. On the FIFO interface side, appropriate logic for vectored access should be designed to allow access to the heads of the FIFOs accessed as a corresponding register of the vector register file 220 by the software being run on the processing unit(s) 102 for data communication between the FIFO and the vector register file 220 as well as for writing prefetched data to the tail of the FIFO (i.e., prefetch operation).

The SCT is a table that holds per-stream information necessary to prefetch data elements of the streams. In some embodiments, one row of the SCT is allocated per stream. The per-stream information includes stream dependency relationship information. By way of an example, in the programming code of c[a[i]]=a[i]+b[i], wherein a, b, and c are arrays in memory 120, and i is the induction variable for looping through elements of the arrays, a separate stream would be initiated for each of i, a, b, and c. The induction variable stream i is referred to as the base stream. The load stream a[i] is directly dependent from the induction variable stream. The load stream b[i] is directly dependent from stream a[i] and indirectly dependent from a[i]. The store stream c[i] is directly dependent from b[i], indirectly dependent from a[i], and indirectly dependent from the base stream with an additional level of indirect dependency compared to the dependency with a[i]. Other per-stream information including the initial value and end value of the induction variable, base address of each of the arrays a, b, and c may also be stored in the SCT.

Reading from the memory 120 into the stream load FIFO 202 and writing data to the tail of stream store FIFO 204 are non-speculative operations performed by the prefetcher 210. Speculative prefetching can happen in case of control-flow, such as if-then-else, operations in the loop. The prefetcher 210 uses the per-stream information from the SCT such as base memory addresses, array induction variable/streams, and vector length to access data elements from memory 120. For maximum performance gain, prefetching may be performed before the software reaches the point wherein the data is required. Notably, for storing streams, the stream FIFOs of the V-SEU 200 are indifferent to the cache write policies of the processing unit(s) 102. For example, a data block of data elements may be prefetched into L1 data cache in memory 120 on write-allocate policy or bypass the cache on write-around policy. In either case, the stream FIFO 204 maintains the processor-produced data based on the data type being used in software. Because data is read/written from/to caches in blocks, the remaining part of each data block that the processing unit(s) 102 writes to is still prefetched from the memory 120.

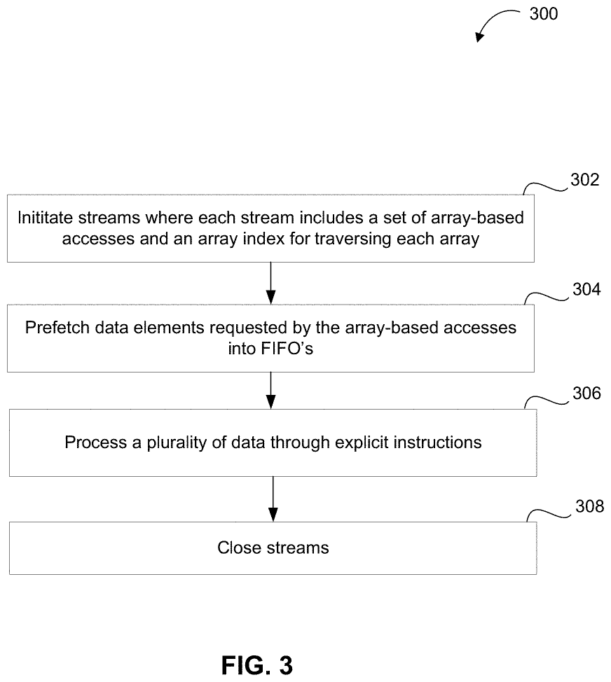

FIG. 3 illustrates a flowchart of a method 300 for executing vector instructions to process a stream of array-based memory accesses. The vector instructions may be part of an application executed by the computing device 100, such as a high-performance computing (HPC), digital signal processing (DSP), artificial intelligence (AI)/machine learning (ML) or computer vision (CV) application. In other embodiments, the vector instructions may be generated from scalar instructions by the vector ISA extension. The method 300 may be carried out by software executed by the respective elements of the V-SEU 200 at least in part. Alternatively, the method 300 may be carried out by software executed by a processing unit(s) 102 of the computing device 100.

At step 302, streams are explicitly initiated or constructed through vector instructions such as a vector_stream_open instruction, wherein the V-SEU 200 is initialized and creates a new vector_stream, which is referred to as a data stream or a vector data stream. Each stream includes a set of array-based memory accesses and the contents of each stream may be accessed through a register in the vector register file 220. Each of the streams is associated with an array index. Each register in the vector register file 220 may be associated with a respective stream of a respective stream FIFOs 202, 204. During this phase, sufficient information may be passed to the prefetcher 210 such that data elements are properly prefetched and stored vector-wise in the corresponding stream FIFOs 202, 204 for later load/store by corresponding instructions. The information provided to prefetcher 210, or stream metadata, are stored in the SCT to enable the start of prefetching operations for the streams. By way of a non-limiting example, in one embodiment, the vector_stream_open instruction is as follows:
vector_stream_open vsid, init_reg, inc, type, isBase, psid/end_val_reg
   wherein the instruction parameters vsid is a vector_stream identifier, init_reg is a register holding the initial value for induction variables or base-address of the array from which the array index depends for direct and indirect streams, inc is an increment value for induction variables, type is indicative of the type of stream which may be INDUCTION, LOAD, STORE, or VECTOR, isBase is a binary value indicating whether the stream is a base stream or not, and psid/end_val_reg is the parent stream identifier for non-base streams, or for base streams, this parameter indicates the register holding the end-value for the induction variable so as to prevent the prefetcher 210 from going beyond the last element of interest.

One stream may be initiated for each array dependency level. In an example, the array index of a vector data stream initiated may be dependent on array values of another set of array-based memory accesses. By way of an example, in the programming code of c[a[i]]=a[i]+b[i], separate streams may be initiated for the base stream induction variable i, directly dependent streams a[i], b[i], and indirectly dependent stream c[a[i]]. The induction variable i is the array index for streams a and b, and values of array b serve as the array index for array c.

At step 304, data elements from the memory 120 are prefetched by the prefetcher 210 into fast memory storages such as the stream FIFOs 202, 204 and readied for consumption. In examples, the data elements may be prefetched from the memory to the fast memory storage by advancing the array index by a plurality of increments. While for each individual prefetch a memory address may be calculated and provided to the memory subsystems, the batch prefetching of the present disclosure does the same in parallel for a multitude of addresses as maximally wide as the number of lanes in the vector system in the processing unit(s) 102. As non-limiting alternative implementations, this could be realized by replicating the address calculation hardware and other necessary resources such as bus lines, or the resource usage could be reduced by sharing some parts among them. The V-SEU 200 may read ahead all entries of a vector stream even though a subset of those streams may actually be used through masking as discussed in more detail below. Some of the data elements may not be actually used due to conditional data access. The V-SEU 200, and more specifically the prefetcher 210, is responsible for prefetching data from memory 120 ahead of execution and without further software intervention after stream initialization by such as the vector_stream_open instruction. The prefetcher 210 may speculatively prefetch the data and maintain it in the vector stream FIFOs 202 and 204.

In one embodiment, by referencing the parent stream (i.e., stream upon which a stream is directly dependent) and the base memory address of the parent stream, prefetching is performed for indirect memory accesses. This saves address-calculation instructions as well as instructions needed for loading index arrays for that batch of indirect memory accesses, and effectively performs the gather/scatter operations, corresponding to indirect load/store operations, fully in hardware, transparent to the software.

The prefetching may be performed on every memory reference, or alternatively, on every cache miss or on positive feedback from prefetched data hits. The prefetched information is stored in the stream FIFOs 202 and 204, and upon reference from a software instruction during execution, the stored data from FIFOs 202, 204 are transferred to/from the vector registers, for respectively load/store operations, in batches.

At step 306, the data elements of the streams are consumed or processed by executing software instructions from the application. The data element consumption is primarily facilitated by storing and loading operations. In an example, a plurality of the prefetched second plurality of data elements are processed by executing a first instruction (e.g., an explicit instruction) for the second vector data stream, and the execution of the explicit instruction causes the processing unit to translate the explicit instruction to a second instruction (e.g., an implicit instruction) to execute a plurality of the prefetched first plurality of data elements.

For loading operations, the V-SEU 200 loads the corresponding data element from a vector stream into a vector register. In one exemplary embodiment, the loading operation may be carried out with the vector instruction of:
vector_stream_load vreg, vsid, offset, mask
   wherein of the instruction parameters, vreg is a vector register to load data to, vsid is an identifier of the vector-stream from which data is loaded, offset is an offset value in each data element to load from, and mask is a bitmask that determines the vector lanes that are enabled for the load operation. Notably, the offset may enable coalescing of multiple vectors composed of data elements at different offset positions. For example, the offset parameter may indicate to the V-SEU 200 to load data elements starting from positions i, i+offset1, i+offset2, etc. of a vector stream into a vector register.

For storing operations, the V-SEU 200 retrieves a vector register value and writes it to a vector stream similar to a vector-transfer operation. In one exemplary embodiment, the storing operation may be performed in response to a vector instruction as follows:
vector_stream_store vsid, vreg, offset, in_mask, conflict_mask
   wherein of the instruction parameters, vsid is the identifier of a vector-stream to store data to, vreg is the vector register to load data to, offset is the offset in each data element to store at, in_mask is a bitmask that indicates the vector lanes that are actually enabled for the store operation, and conflict_mask represents a conflict mask that is an output bitmask that indicates elements of a vector that have conflicts. In some embodiments, the storing instruction does not perform the store operation on conflicting elements, instead, it is left to the software to resolve the conflict afterwards.

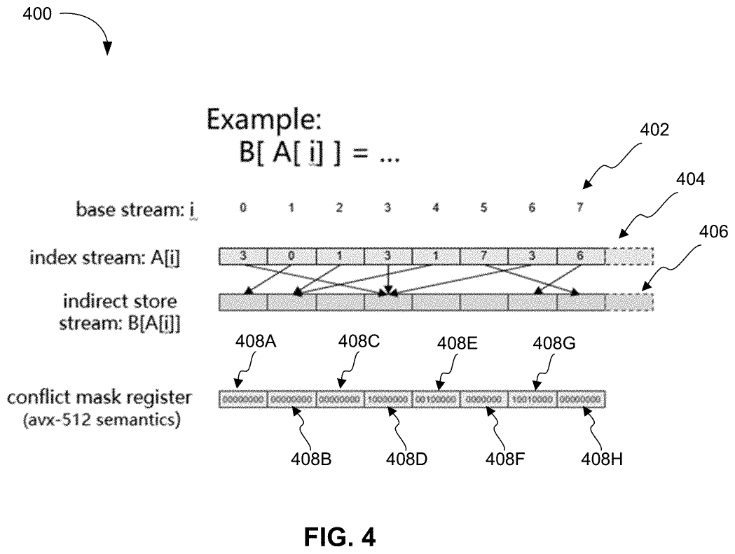

In certain embodiments, there exists the possibility of duplicate entries in the one or more of the stream FIFOs 202, 204 for duplicate addresses in the “index” streams. FIG. 4 illustrates an example of simplified index streams in which duplicate entries in one stream causes conflicts in another stream. As shown, during execution of the example code of “B[A[i]]”, the base stream i 402 includes values of the induction variable i. The index stream 404 includes references to elements of array A[i] that serves as indices values for the B stream. The indirect store stream 406 includes references to elements of array B[ ] generates an indirect store stream because the value of stream B is being assigned, or stored. Elements in the base stream 402 for induction variable i is incremented by 1 as shown. However, the elements in the index array 404 contains duplicate entries, specifically elements A[0], A[3], and A[6], which all contain values of 3 such that all three, when served as an index value, point to the same element location in array B. Similarly, elements A[2] and A[4] both contain values of “1”, which, when served as array indices for array B[ ], may cause conflict by referring to the same element in array B[ ]. Consequently, when B[A[i]] is to be fetched during prefetching operations, i.e. a load operation, the corresponding elements of B[ ] is repeatedly written to multiple elements of the same vector in the FIFO 202. In case of vector load instructions this does not cause issues, but for vector store instructions, i.e. a scatter operation, different values in a vector corresponding to the same memory location in array B[ ] causes conflicts that results in loss of data.

To resolve the conflict, as part of the vectorized storing instruction, the V-SEU 200 detects the conflict. In some embodiments, a conflict detection ISA may be used. By way of a non-limiting example, a run-time conflict detection instruction vec_conf_detect introduced in Advanced Vector Extensions (AVX)-512, which are extensions to the x86 instruction set architecture for processing units, may be used to detect conflicts. In this particular embodiment, the instruction determines the conflicts among vector elements, and returns a mask that is used in subsequent vector instructions to avoid the conflicting vector elements in the following pseudo code:
v_lane_conf_mask=vec_conf_detect(v_index)
   where v_index is an index of an array in question.

In FIG. 4, elements of array A[i] may be passed as v_index to instruction vec_conf_detect to detect conflicts for indirect stream for array B. Each stream is of a vector length (VL) of 8. The conflict determination is made at each array index, and masks 408A-408H (collectively referred to as masks 408) may be returned that are indicative of elements wherein conflicts exist. In the exemplary embodiment shown in FIG. 4, each of the masks 408 is comprised of VL number of bits. As may be observed, for the first three elements of array A[ ], or the first three indices of array B[ ], have respective values of 3, 0, and 1, and no conflict is detected. The corresponding masks 408A, 408B, and 408C are comprised of “0”s indicative of no conflict. The fourth element of array A[ ], or the fourth index value of array B[ ], has a value of “3”, which is a duplicate of the first array index for B[ ]. The conflict determination function returns mask 408D having a “1” in the first bit, indicating the presence of a conflict with the first array index. Similarly the fifth array element, namely B[A[4]] references B[1], which conflicts with B[A[2]] at the same array location. The corresponding mask 408E returns a mask with the third bit of “1” indicating a conflict with the third array index. The mask 408G indicates there are conflicts with both index values of A[0] and A[3].

In some embodiments, the vector_stream_store instruction returns a conflict_mask that is taken into account by the software code to properly resolve the detected conflicts.

In resolving detected conflicts, the software code, upon receipt of the conflict_mask, may serialize writing to the conflicting vector elements, and operate each data element in the same order as the original non-vectorized software code so that the original semantics is kept intact. In some embodiments, the V-SEU 200 may revert the instructions from a vector version to a scalar version of a loop for vector-length iterations upon detecting a conflict. In that case, the scalar version of the loop, which has also been produced by the compiler, is executed. In this conflict resolution method, all elements of the vector are serialized. This may be simpler to implement but imposes unnecessary serialization on conflict-free elements.

In some further embodiments, detected conflicts may be resolved by serializing operations on conflicting elements only. Again, the outcome of the conflict-detection identifies the vector lanes that are conflicting, such as 408D, 408E, and 408G, and only serializes these ones, namely vector lanes corresponding to base stream values 3, 4, and 6. The semantics of the original non-vector code is kept intact, while parallelism is kept for non-conflicting elements.

During data processing (or data consumption), the stream steps update associated induction variables by advancing the register position of all dependent streams. Vector streams are advanced with multiples of vector-length. As data is consumed/produced in vectors, at the end of each round of access in the loop, the streams are moved forward by vector-length elements. The same for the induction variable of the vectorized loop. Similarly, the induction variable of the corresponding loop is always advanced by multiples of the vector-length, thus enabling the advancement of the register position by multiples of vector length.

When a loop is vectorized, all accesses to the streams are vector-length aligned. Thus, in some embodiments, scalar and vector streams may not be mixed under each base stream, including nested loops wherein in the inner loop accesses are made using the outer loop induction variable. For accesses using separate base-streams, however, the loops can be independently scalar or vector.

At step 308, at the end-of-life of the streams, each stream is closed and its occupied resources in the V-SEU 200 are returned back to the system. An example stream close instruction may be as follows:
vector_stream_close sid
   wherein sid is the identifier of the base stream of the stream tree to close, which would in turn cause all dependent vector streams to close.

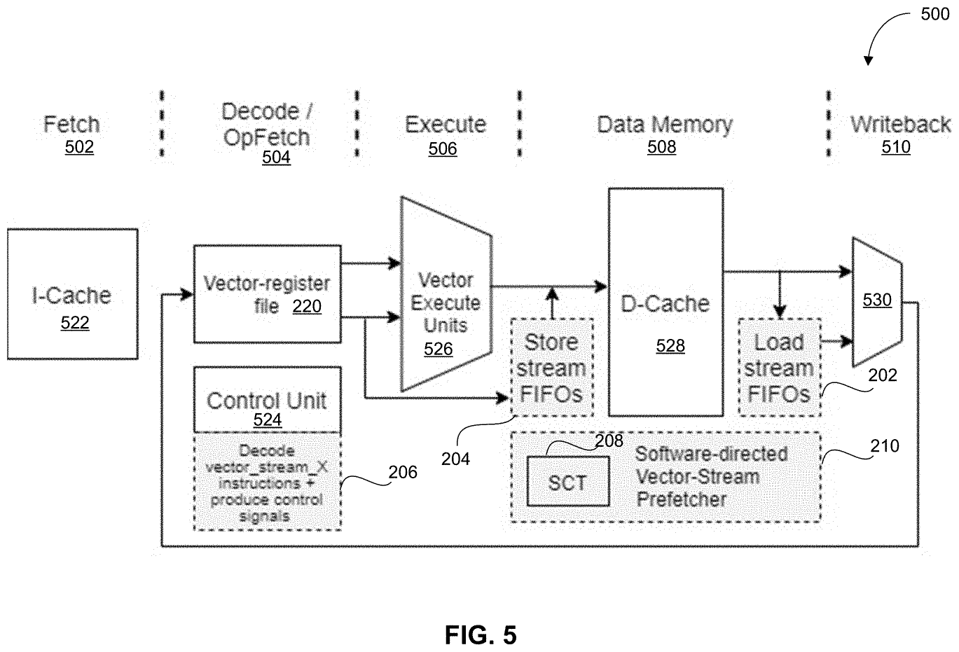

FIG. 5 illustrates a vector instruction processing pipeline 500 in accordance with an example embodiment of the present disclosure. The processing pipeline 500 has five processing stages: a Fetch stage 502, Decode/OpFetch stage 504, Execute stage 506, Data Memory stage 508, and a Writeback stage 510. The Fetch stage 502 reads vector instructions from an instruction cache 522 and passes the vector instructions to the next stage, the Decode/OpFetch stage 504. The Decode/OpFetch stage 504 decodes the vector instructions and fetches operand values for vector instruction execution. In the Decode/OpFetch stage 504, the vector_stream_X instructions are identified and a control unit 524, such as the processing unit(s) 102, process the vector instruction by producing appropriate control signals. The vector controller 206 of the V-SEU 200 (FIG. 2) is a component of the control unit 524. The vector register file 220 is also accessed in the Decode/OpFetch stage 504 in response to a required read from the vector register file 220 by the vector_stream_X instruction being processed. In the Execute stage 506, vector execution units 526 perform vector computations as per the vector instruction being executed. The resulting data is passed to the Data Memory stage 508 in which load data from memory and storing data to memory occurs. In the Data Memory stage 508, the Load Stream FIFO(s) 202 read out data elements of the vector streams from a data cache (D-Cache) 528 and assembles the data elements to be written back to the vector register file 220 in the Writeback stage 510. In the Data Memory stage 508, the Store Stream FIFO(s) 204 temporarily store data to be streamed into the D-Cache 228. A bypass path at the Execute stage 506 may be used to directly pass data from vector register file 220 to the Store Stream FIFO(s) 204 without processing by the vector execution units 526, depending on the control signal generated for the respective instructions. As noted above, the Stream Configuration Table (SCT) is an information table that contains the configuration information of the currently active vector streams. The software-directed vector stream prefetcher 210 is a hardware unit that controls reading out and writing in of the vector stream data on the D-Cache 528. The Writeback 510 stage is where data is written back to the vector register file 220 by a multiplexer 530. The multiplexer 530 corresponds to the multiplexer 230C in FIG. 2. The data may be provided from the D-Cache 528 directly as in conventional processing units or provided from Load Stream FIFO(s) 202 in accordance with example embodiments of the present disclosure, depending on the control signal generated for the respective instructions.

The pipeline 500 shows the relative position of added hardware components to the processing unit 202 with respect to the data path in various stages of the processing pipeline. The components with dashed outlines show the added components so that the vectorized stream instructions may be decoded in accordance with the present disclosure. The stream FIFOs 202, 204 are respectively shown before and after (left and right of) the data cache L2 528 as data is read from memory 120 and stored in the load stream FIFOs 204, and it is written to the memory 120 from the store stream FIFOs 202. The software-directed vector-stream prefetcher 210 perform prefetching operations by utilizing the stream information stored in the SCT to identify how and wherein from the prefetching should be done for each stream, and issues necessary control signals to appropriate units in the processor accordingly. As explained above, the exact operations and signals are implementation-dependent and would differ from processor to processor based on how hardware prefetching is done (if at all) in that processor. The important addition of this disclosure is the batched prefetching corresponding to maximally vector-length worth of prefetches. The batch of memory addresses are calculated. If the addresses overlap, they are coalesced into smaller number of memory requests. Then these memory requests are passed to the memory subsystem 120 and the returning data is stored in stream FIFOs 202 and 204.

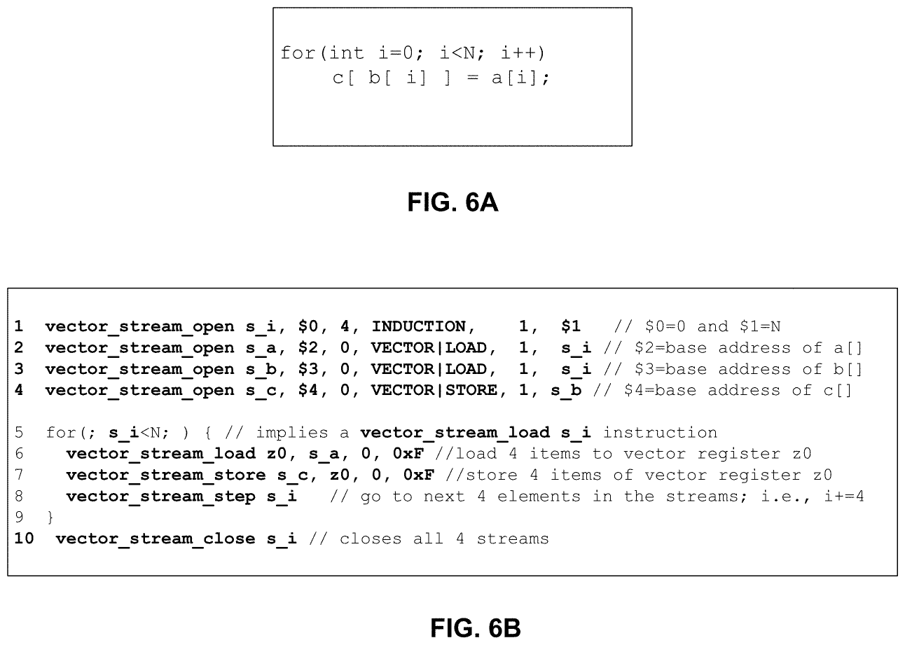

FIGS. 6A and 6B show sample code to illustrate operations of the present disclosure. FIG. 6A shows a sample code of a loop generating array-based memory access instruction. FIG. 6B shows sample code corresponding to the sample code of FIG. 6A expressed in vectorized stream instructions in accordance with exemplary embodiments of the present disclosure.

As shown in FIG. 6B, instructions in lines 1 to 4 initiate the streams starting from the induction variable stream, s_i, on line 1, and then continuing on initiating the remaining streams s_a, s_b, and s_c corresponding to accesses to the a[ ], b[ ] and c[ ] arrays. By these instructions, the V-SEU 200 receives enough information, through instruction parameters, to begin prefetching data elements of a[i], b[i], and c[b[i]] data streams

Inside the loop, there is no need to calculate addresses for a[i] elements, nor for b[i] and c[b[i]]. In fact, loads from b[i] are eliminated altogether. Simply a load from stream s_a and storing to stream s_c is all that is necessary at lines 6 and 7, respectively. By executing the explicit load and store operation, the stream b[i] is implicitly executed. This happens because the relation between b[ ] and c[ ] has already been passed to the V-SEU 200, and hence, any access to c[ ] implies a corresponding access to b[ ].

In the stream initiation command for the base stream at line 1, the vector length (VL) is set to 4. Thus, to advance to the next iteration of the loop, the induction variable i would need to be incremented by 4. This is done by line 8, which also causes the other three streams of s_a, s_b, and s_c go advance to their next 4 vectors due to their dependency on s_i as the base stream.

Finally, at line 10, all four streams are closed (or destructed) by instructing the hardware to close the base stream s_i and all its dependent streams.

General

Through the descriptions of the preceding embodiments, the present invention may be implemented by using hardware only, or by using software and a necessary universal hardware platform, or by a combination of hardware and software. The coding of software for carrying out the above-described methods described is within the scope of a person of ordinary skill in the art having regard to the present disclosure. Based on such understandings, the technical solution of the present invention may be embodied in the form of a software product. The software product may be stored in a non-volatile or non-transitory storage medium, which can be an optical storage medium, flash drive or hard disk. The software product includes a number of instructions that enable a computing device (personal computer, server, or network device) to execute the methods provided in the embodiments of the present disclosure.

All values and sub-ranges within disclosed ranges are also disclosed. Also, although the systems, devices and processes disclosed and shown herein may comprise a specific plurality of elements, the systems, devices and assemblies may be modified to comprise additional or fewer of such elements. Although several example embodiments are described herein, modifications, adaptations, and other implementations are possible. For example, substitutions, additions, or modifications may be made to the elements illustrated in the drawings, and the example methods described herein may be modified by substituting, reordering, or adding steps to the disclosed methods.

Features from one or more of the above-described embodiments may be selected to create alternate embodiments comprised of a subcombination of features which may not be explicitly described above. In addition, features from one or more of the above-described embodiments may be selected and combined to create alternate embodiments comprised of a combination of features which may not be explicitly described above. Features suitable for such combinations and subcombinations would be readily apparent to persons skilled in the art upon review of the present disclosure as a whole.

In addition, numerous specific details are set forth to provide a thorough understanding of the example embodiments described herein. It will, however, be understood by those of ordinary skill in the art that the example embodiments described herein may be practiced without these specific details. Furthermore, well-known methods, procedures, and elements have not been described in detail so as not to obscure the example embodiments described herein. The subject matter described herein and in the recited claims intends to cover and embrace all suitable changes in technology.

Although the present invention and its advantages have been described in detail, it should be understood that various changes, substitutions and alterations can be made herein without departing from the invention as defined by the appended claims.

The present invention may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples but should be given the broadest interpretation consistent with the description as a whole.

1. A method of processing vector data streams by a processing unit, the method comprising:
initiating a first vector data stream for a first set of array-based memory accesses, wherein the first vector data stream is associated with a first array index, wherein the first array index is an induction variable;
initiating a second vector data stream for a second set of array-based memory accesses, wherein the second vector data stream is associated with a second array index, wherein the second array index is dependent on array values of the first set of array-based memory accesses;
prefetching a first plurality of data elements requested by the first set of array-based memory accesses from a memory into a first fast memory;
prefetching a second plurality of data elements requested by the second set of array-based memory accesses from a vector register file into a second fast memory storage; and
processing a plurality of the prefetched second plurality of data elements through an execution of a first instruction for the second vector data stream, wherein the execution of the first instruction causes a second instruction executed for a plurality of the prefetched first plurality of data elements.

2. The method of claim 1, wherein the first plurality of data elements and the second plurality of data elements are prefetched based on stream information stored in a stream configuration table (SCT).

3. The method of claim 2, wherein an initial value and end value of the induction variable and base address of the first set of array-based memory accesses are stored in the SCT for the first vector data stream.

4. The method of claim 2, wherein the stream information of the SCT includes stream dependency relationship information.

5. The method of claim 1, further comprising:
determining conflicts in the second plurality of data elements prior to prefetching the second plurality of data elements; and
serializing at least the conflicting data elements of the second plurality of data elements in response to detection of a conflict during the prefetching of the second plurality of data elements.

6. The method of claim 5, wherein the conflicting data elements are serialized during the prefetching of the second plurality of data elements.

7. The method of claim 6, further comprising:
generating a conflict mask in response to detection of a conflict; and
wherein the conflicting data elements are serialized using the conflict mask.

8. The method of claim 1, wherein the vector data streams are processed while maintaining dependency relationships between arrays of the vector data streams, wherein array-index calculation is performed in batches by determining array-index values from registers of the vector register file based on the dependency relationships.

9. The method of claim 1, further comprising:
converting the first instruction to the second instruction.

10. A system, comprising:
a first fast memory storage for temporarily storing data of vector data streams from a memory for loading into a vector register file;
a second fast memory storage for temporarily storing data of the vector data streams from the vector register file for loading into the memory;
a prefetcher configured to
prefetch data of the vector data streams from the memory into the first fast storage memory, and
prefetch data of the vector data streams from the vector register file into the second fast storage memory; and
a stream configuration table (SCT) storing stream information for prefetching data from the vector data streams.

11. The system of claim 10, wherein an initial value and end value of the induction variable and base address of the first set of array-based memory accesses are stored in the SCT for the first vector data stream.

12. The system of claim 11, wherein the stream information of the SCT includes stream dependency relationship information.

13. The system of claim 11, wherein the first fast memory storage and second fast memory storage are First-In-First-Out (FIFO) buffers.

14. The system of claim 13, wherein the FIFOs have a size based on a prefetching depth.

15. The system of claim 14, wherein the data in each vectorized data stream is accessed in vector batches of a fixed size and the FIFO size is a multiple of a size of the vector batches of the vector data streams.

16. The system of claim 11, wherein multiplexers select signals of the vector stream engine unit and pass the selected signal to the memory or vector register file in accordance with a respective signal type.

17. The system of claim 11, wherein the vector data streams are comprised of a sequence of memory accesses having repeated patterns that are the result of loops and nested loops.

18. The system of claim 11, wherein the vector data streams are classified into two groups consisting of memory streams that define a memory access pattern and induction streams that define a repeating pattern of values.

19. The system of claim 18, wherein memory streams are dependent on either an induction stream for direct memory access or another memory stream for indirect memory access.

20. The system of claim 11, wherein the vector stream engine unit further comprises a compiler for compiling source code and porting the compiled code to at least one processing unit of a host computing device for execution.
